(19) United States
(12) Patent Application Publication
(10) Pub. No.: US 2024/0415357 A1
(43) Pub. Date: Dec. 19, 2024

(54) WATER-EFFICIENT SURFACE CLEANING METHOD AND SYSTEM

(71) Applicant: Nir BEN-ZEEV, Kiryat Tivon (IL)

(72) Inventor: Nir BEN-ZEEV, Kiryat Tivon (IL)

(21) Appl. No.: 18/699,430

(22) PCT Filed: Oct. 3, 2022
(86) PCT No.: PCT/IL2022/051048

§ 371 Date: Apr. 8, 2024

(30) Foreign Application Priority Data
Oct. 11, 2021 (IL) 287154

(51) Int. Cl. A47L 11/40; A47L 9/04; A47L 9/28; A47L 11/282; A47L 11/38

(52) U.S. Cl. CPC A47L 11/4002; A47L 9/0477; A47L 9/281; A47L 11/282; A47L 11/38; A47L 11/4011; A47L 11/4041; A47L 11/4044; A47L 2201/06

(57) ABSTRACT

A surface cleaning system comprising one or more cleaning elements and a discharger module adapted for breaking the static charge attraction between the surface and the persistent dirt residues attached thereto.

### FIELD OF THE INVENTION

The present invention is in the field of surface cleaning apparatus. More specifically, the invention relates to a water-efficient surface cleaning method and an applied cleaning system thereof.

### BACKGROUND OF THE INVENTION

Cleaning large surfaces, particularly surfaces exposed to solidifying residues (e.g., external window panels, horizontal floor surfaces, etc.), is a major challenge for epochs.

The market offers various cleaning systems that use distilled water, high-pressure water, multiple chemicals, and polishing systems. However, the existing cleaning systems consume significant quantities of water, detergents, man power and power supply for softening removing dirt residues persistently attached to surfaces by static charges stored therein. Moreover, the extensive use of water for softening these persistent dirt residues commonly leaves water residues to dry and re-stain the cleaned surface.

Therefore, it is an object of the present invention to provide a method and an applicative system for effectively cleaning surfaces, while consuming reduced quantities of water.

Other objects and advantages of the invention will become apparent as the description proceeds.

### SUMMARY OF THE INVENTION

In one aspect, the present invention relates to a surface cleaning method, comprising applying one or more cleaning operations in conjunction with discharging static charges stored by said surface and by persistent dirt residues attached thereto.

According to an embodiment of the present invention, the one or more cleaning operations involves one or more of the following steps: brushing the surface being cleaned by suitable rigid brushing means, brushing said surface and collecting the removed dirt, burnishing said surface by wet cleaning followed by wiping operations performed by wetting and wiping means, or any combination thereof.

The discharging static charges may be applied by streaming conductive air over said surface and the persistent dirt residues attached thereto.

According to an embodiment of the present invention, the wet cleaning is performed by streaming fluid selected from the group consisting of: sprayed water, jetted water, water mixed with detergent substance, steam, or any combination thereof.

In another aspect, the present invention relates to a surface cleaning system, comprising one or more cleaning elements and a discharger module adapted for breaking the static charge attraction between said surface and the persistent dirt residues attached thereto.

According to an embodiment of the present invention, the system further comprises a) a control module adapted to control the operation of said system, b) a soft brush module adapted to brushing said surface, c) a collector module adapted to collect removed dirt, d) a burnish module, adapted to wet clean and to wipe said surface, and a navigation module adapted to manage the advancing of said surface cleaning system over said surface.

According to an embodiment of the present invention, the discharger module is an ionizer module, adapted to stream conductive ionized air over said surface and the persistent dirt residues attached thereto.

According to an embodiment of the present invention, the control module comprises a communication module for enabling communicating with one or more remote stations.

According to an embodiment of the present invention, the system further comprises a sensing module for detecting the dirt residues at the surface to be cleaned.

According to an embodiment of the present invention, the control module is adapted to process the information acquired by the sensing module by AI algorithms.

According to an embodiment of the present invention, the collector module comprises a vacuum generating device, a collection container for storing collected dirt residues, suction nozzles positioned at desirable locations, and corresponding collection tubes therebetween.

According to an embodiment of the present invention, the navigation module comprises an attachment module for enabling the advancing of the system on vertical surfaces.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a block diagram of exemplary cleaning steps of the proposed method, according to an embodiment of the present invention; and

FIG. 2 schematically illustrates an exemplary configuration of a water-efficient surface cleaning system, according to an embodiment of the present invention; and

FIGS. 3A and 3B illustrate a partial configuration of a water-efficient surface cleaning system 300 as well as its travel direction along a cleaned surface 310 indicated by an arrow with the letter ‘F’, according to an embodiment of the invention.

### A DETAILED DESCRIPTION OF THE INVENTION

The present invention relates to a water-efficient surface cleaning method and a realized cleaning system thereof. The proposed method involves one or more cleaning operations, in conjunction with discharging static charges stored by said surface and by persistent dirt residues attached thereto.

The present invention also relates to a system that is adapted for applying the proposed surface cleaning method.

In the following detailed description, references are made to several embodiments of the present invention, examples of which are illustrated in the accompanying figures. The figures depict embodiments of the present invention for purposes of illustration only. One skilled in the art will readily recognize from the following description that the described embodiments may be combined, alternative embodiments may be utilized, and other changes may be made without departing from the spirit or scope of the present invention described herein.

The terms “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

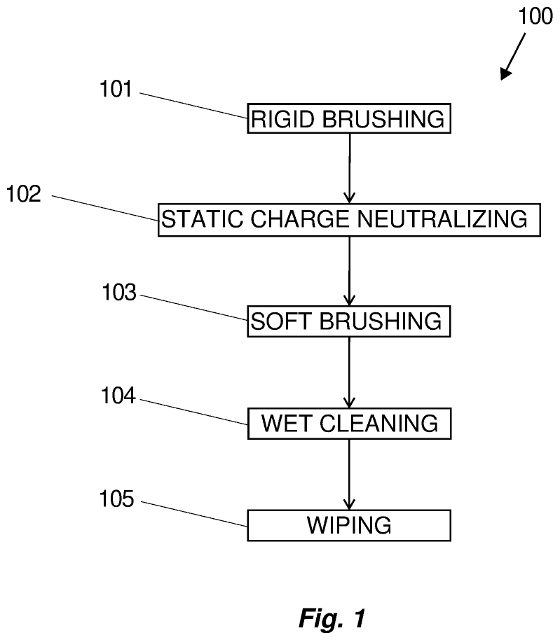

FIG. 1 is a bloc diagram of exemplary cleaning operations of a surface cleaning method 100, according to an embodiment of the present invention. The surface cleaning process of method 100 begins with an initial brushing of solidified dirt (block 101), for instance, by operating a rotating brush over the cleaned surface, thereby dismantling and removing brittle solid dirt matter.

The following step 2 (block 102) is discharging the surface to be cleaned and persistent dirt residues from static charges, thus neutralizing the attraction therebetween, for instance, by streaming conductive air over the surface being cleaned and dirt residues attached thereon (e.g., by an ionized air blower), or by contacting the surface to be cleaned with a conductive element, or by any other discharging means. The discharging operation enables the detachment of the persistent dirt residues from the cleaned surface and its consecutive removal in the following steps.

Step 3 (block 103) includes brushing the discharged persistent dirt residues from the discharged surface, for example, by a soft brush and collecting the brushed residues (e.g., by a peripheral vacuum module extracting the brushed resides to a suitable collection container).

Whereas the persistent dirt residues are collected, burnishing of the surface by wet cleaning (e.g., spraying or jetting a liquid such as water, or steam, with or without cleaning detergent), and by wiping (e.g., wiping and drying the wet/humid surface by a suitable rotating brush) executed at steps 4 (block 104) and 5 (block 105) of FIG. 1.

Of course, alternative sequencing of the operations/steps of method 100 may be selected by one skilled in the art in accordance with specific applications of the proposed surface cleaning method. For example, the discharging step (block 102) may be applied and/or repeated at the end of the cleaning operations, such as to verify that the cleaned surface is free of static charges, thus preventing its attraction of new dirt particles (e.g., airborne dust) right after the surface cleaning was completed.

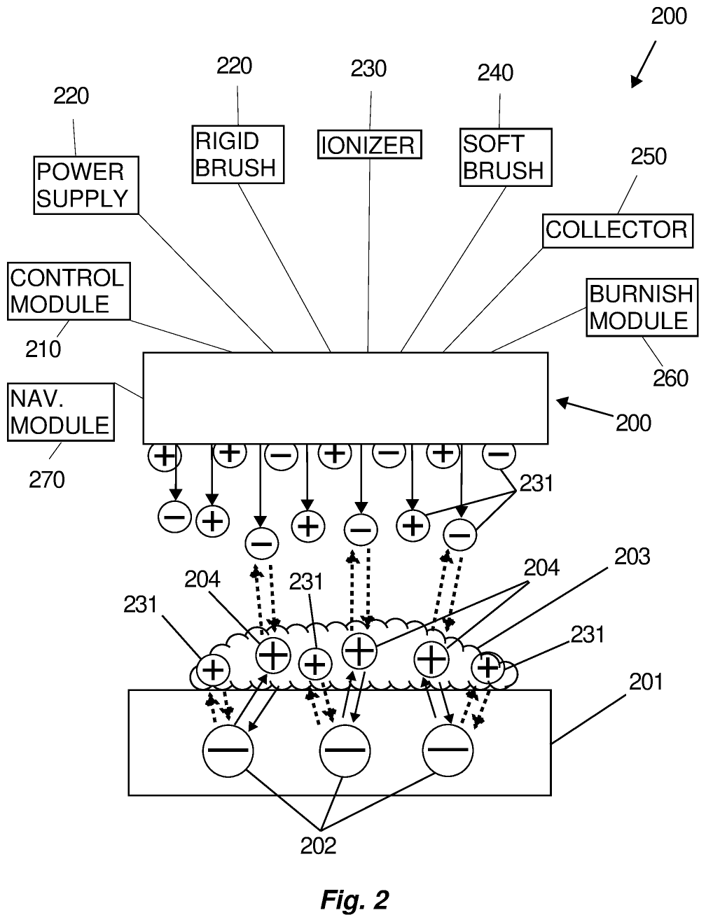

FIG. 2 schematically illustrates an exemplary configuration of a water-efficient surface cleaning system 200, according to an embodiment of the present invention.

System 200 comprises a discharger module, such as an ionizer module 230 (e.g., utilizing AC/DC/Pulse Corona ionization, or other ionization, and a suitable air blowing device) for performing step 2 of method 100 and one or more cleaning elements (e.g., brushing, burnishing, scrubbing, or other suitable forms of cleaning means), such as to perform cleaning operations (e.g., steps 1 and 3-5 of method 100).

For example, in addition to a discharger module, implementations of system 200 may comprise at least one of the following modules:
a control module 210 and a power supply module 220 for controlling and supplying power to system 200.
a rigid brush module 220 (e.g., a rigid brush and its rotation/vibration mechanism) for performing step 1 of method 100;
a soft brush module 240 (e.g., a rotating soft brush) for performing step 3 of method 100;
a collector module 250 (e.g., a vacuum generating device adapted with a collection container accommodating collected dirt residues, suction nozzles positioned at desirable locations for collecting removed dirt and corresponding collection tubes therebetween) for collecting removed dirt along with desired cleaning steps 1-5 of method 100;
a burnish module 260 (e.g., employing a steam jetting means and a wiping brush) for performing steps 4 and 5 of method 100; and
a navigation module 270 for managing the advancing of system 200 over surface 201.

One skilled in the art can readily understand that the physical arrangement of modules 220-260 within system 200 with respect to its advancing direction over the cleaned surface 201 corresponds to the cleaning steps of the applied steps of cleaning method 100. For example, rigid brush module 220 is positioned in the front portion of system 200, ionizer module 230 is next, etc. Operating collector 250 may be required along with multiple cleaning steps. It is optionally adapted with multiple suction nozzles distributed near corresponding modules (e.g., near modules 220, 240, and 260) or with one or more peripheral suction nozzles facing surface 201.

Optionally, controller 210 may comprise a communication module (not shown) for enabling communication between one or more remote stations and controller 210. For example, the communication can be utilized to update the operational software or obtain direct control of modules 220-270 (e.g., returning system 200 to its origin in case of faulty operation).

According to an embodiment of the invention, system 200 further comprises a sensing module, such as an image acquiring module (not shown) for detecting the dirt level at surface 201, while control module 210 is adapted to receive the information acquired by the sensing module and correspondingly operate modules 220-270, thereby to perform a more accurate cleaning operation adapted to the dirt level over the surface being cleaned. Furthermore, control module 210 utilizes AI algorithms to continuously compare the initial assessed dirt level with the final cleanliness obtained, considering the cleaning operations performed until the desired cleanliness level was obtained, such as to improve its water and detergents consumption. For example, for certain types and levels of dirt, shorter operation of rigid brush module 220, followed by more intense operation of ionized air module 230 may enable a shorter operation of burnishing module 260 for obtaining the same cleanliness level, while reducing water consumption.

According to another embodiment of the invention, navigation module 270 of system 200 is adapted to enable advancing of system 200 over vertical surfaces 201 such as windows' surface, by employing an attachment module for allowing the advancing of system 200 on vertical surfaces while being attached thereto, such as attachment system disclosed by U.S. Pat. No. 10,383,492.

Further illustrated in FIG. 2 is the discharging operation performed by ionizer module 230. In this example, an isolated surface 201 (e.g., a window panel peripherally confined by a rubber sealing material installed between the window panel and its framing) is initially charged with static charges 202, while dirt residues 203 statically charged with charges 204 are persistently attached to surface 201 due to the attraction force between charges 202 and 204.

Module 230 streams ionized air charged with charges 231, where the conductive air streamed over surface 201 and dirt residues 203 enables discharging of charges 202 and 204 therefrom, thereby breaking the initial attraction between dirt residues 203 and surface 201 and enabling the removal of dirt residues 203 by modules 240-260.

The discharging operation performed by ionizer module 230, is highly advantageous as breaking the initial attraction between surface 201 and dirt residues 203, significantly reduces its persistent attachment to surface 201, thus reduces the water/steam/detergent quantities that are required for removing dirt residues 203 as well as operation time of other modules of system 200.

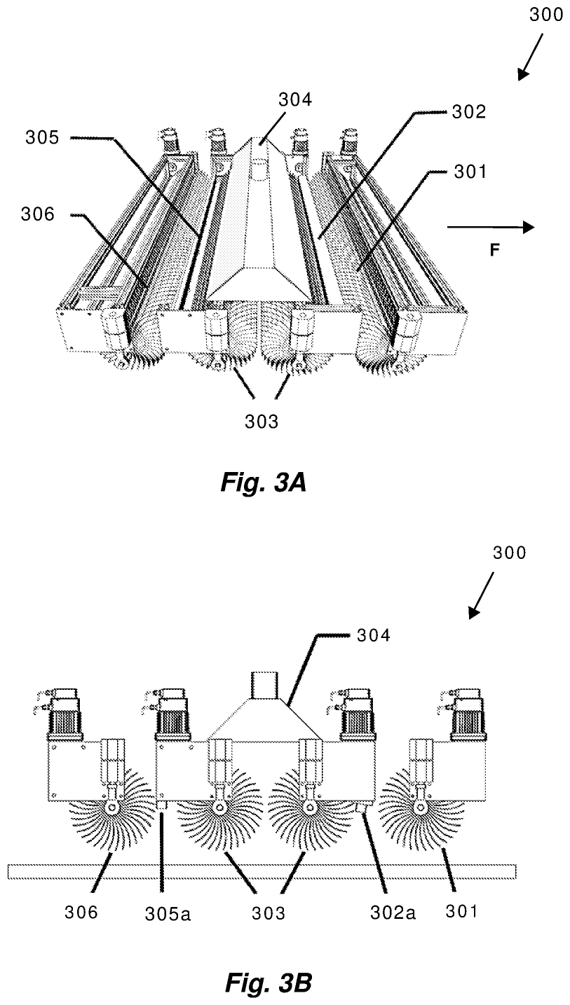

FIGS. 3A and 3B illustrate a partial configuration of a water-efficient surface cleaning system 300 as well as its travel direction along a cleaned surface 310 indicated by an arrow with the letter ‘F’, according to an embodiment of the invention. System 300 comprises a first rotatable brush 301 (e.g., for applying the initial brushing operation of method 100), an air ionizer 302 having a conductive air outlet 302a (e.g., for applying step 2 of method 100), soft brushes 303 for brushing detached dirt being collected by a vacuum module 304 (e.g., applying step 103 of method 100), a wet cleaning module 305 having outlet nozzles 305a (e.g., a thin water sprayer with a plurality of nozzles), and a final wiping brush 306 for burnishing the cleaned surface (e.g., steps 104 and 105 of method 100).

Although embodiments of the invention have been described by way of illustration, it will be understood that the invention may be carried out with many variations, modifications, and adaptations, without exceeding the scope of the claims.

1-12. (canceled)

13. A surface cleaning method for effectively cleaning surfaces, while consuming reduced quantities of water, comprising:
a) applying one or more cleaning operations through cleaning modules that includes at least one of brushing with rigid means, collecting removed dirt, and burnishing followed by wiping; and
b) in conjunction with discharging, by a discharger module, static charges from a surface and persistent dirt residues thereon, thereby neutralizing the attraction between persistent dirt residues and said surface by discharging static charges therein, thereby and enabling the detachment of said persistent dirt residues from said surface, wherein a control module is configured to regulate the operation of the cleaning modules and the discharger module based on the condition of the surface and the extent of the persistent dirt residues, thereby providing a cleaning sequence that ensures effective cleaning with reduced water consumption.

14. A method according to claim 13, wherein the applying of one or more cleaning operations in conjunction with neutralizing the electric attraction between persistent dirt residues and said surface, comprises the steps of:
a) brushing of solidified dirt, by a rigid brush module;
b) neutralizing the electric attraction between persistent dirt residues and said surface, by discharging static charges stored therein by a discharger module; and
c) brushing the discharged persistent dirt residues from said surface by a soft brush module.

15. A method according to claim 13, wherein the one or more cleaning operations further comprises cleaning operations selected from the group consisting of: collecting dirt residues by a collector module, wet cleaning the surface, wiping said surface, or any combination thereof.

16. A method according to claim 13, wherein the discharging static charges is applied by streaming conductive air over said surface and the persistent dirt residues attached thereto.

17. A method according to claim 14, wherein the wet cleaning is performed by streaming fluid selected from the group consisting of: sprayed water, jetted water, water mixed with detergent substance, steam, or any combination thereof.

18. A surface cleaning system for effectively cleaning surfaces, while consuming reduced quantities of water, comprising: a control module adapted to control the operation of said system, one or more a) a plurality of cleaning modules including at least brush modules for brushing operations, a collector module for collecting removed dirt, and a burnish module for wet cleaning followed by wiping; and b) a discharger module adapted to discharge static charges, thus neutralizing the attraction between persistent dirt residues and said surface, and thereby enabling the detachment of said persistent dirt residues from said surface; and c) a control module adapted to control the operation of said cleaning modules and said discharger module based on the condition of the surface and the extent of the persistent dirt residues, thereby providing a cleaning sequence that ensures effective cleaning with reduced water consumption.

19. A system according to claim 18, wherein the one or more cleaning brush modules comprise:
a) a rigid brush module for brushing of solidified dirt; and
b) a soft brush module adapted to brushing the discharged persistent dirt residues from said surface.

20. A system according to claim 18, wherein the one or more cleaning modules further comprise cleaning modules selected from the group consisting of:
a) a collector module adapted to collect removed dirt; and
b) a burnish module, adapted to wet clean and to wipe said surface.

21. A system according to claim 18, wherein the discharger module is an ionizer module, adapted to stream conductive ionized air over said surface and the persistent dirt residues attached thereto.

22. A system according to claim 18, wherein the control module comprises a communication module for enabling communication with one or more remote stations.

23. A system according to claim 18, further comprises a sensing module for detecting the dirt residues at the surface to be cleaned.

24. A system according to claim 18, wherein the control module is adapted to process the information acquired by the sensing module by AI algorithms.

25. A system according to claim 20, wherein the collector module comprises a vacuum generating device, a collection container for storing collected dirt residues, suction nozzles positioned at desirable locations, and corresponding collection tubes therebetween.

26. A system according to claim 18, further comprises a navigation module adapted to manage the advancing of said surface cleaning system over said surface.

27. A system according to claim 16, wherein the navigation module comprises an attachment module for enabling the advancing of the system on vertical surfaces.
